(19) United States
(12) Patent Application Publication
(10) Pub. No.: US 2019/0390654 A1
(43) Pub. Date: Dec. 26, 2019

(54) WIND TURBINE

(71) Applicant: NVB WINDMILL ENERGY INTERNATIONAL LTD, Berkshire (GB)

(72) Inventor: Nicolaas VAN DER BLOM, Unterägeri (CH)

(21) Appl. No.: 16/485,062

(22) PCT Filed: Feb. 12, 2018
(86) PCT No.: PCT/IB2018/000094

§ 371 Date: Aug. 9, 2019

(30) Foreign Application Priority Data
Feb. 9, 2017 (DE) 10 2017 001 199.0
Feb. 10, 2017 (DK) PA 2017 00095
Nov. 9, 2017 (DE) 10 2017 010 387.9

(51) Int. Cl. F03D 9/34; F03D 3/04; F03D 9/17; F03D 9/28

(52) U.S. Cl. CPC F03D 9/34; F03D 3/04; F05B 2260/406; F03D 9/28; F03D 9/17

(57) ABSTRACT

A wind mill for generating wind power, for the conversion of said wind power into electricity and for conserving gained wind power for later use, said wind mill us comprising a rotor or a propeller which is communicating with a 1st axle, for generating a turning moment for said 1st axle, said rotor or propeller is rotating in a flow of wind, further comprising a pump, which is communicating with said 1st axle, This is accomplished by said wind mill is communicating with a Motor, the last mentioned is comprising said pump which is comprising a piston-chamber combination, said combination is comprising a chamber which is bounded by an inner chamber wall, and comprising a piston in said chamber to be engagingly movable relative to said chamber wall at least between a first position and a second position of said chamber, said chamber having cross-sections of different cross-sectional area's at the first and second longitudinal positions, and at least substantially continuously differing cross-sectional area's at intermediate longitudinal positions between the first and second longitudinal positions, the cross-sectional area at said second longitudinal position being smaller than the cross-sectional area at said first longitudinal position, for pressurization of a fluid, and is communicating with said 1st axle, a pressure storage vessel is communicating with said pump, for storage of compressed fluid, and said Motor is communicating with a generator, said generator is providing electricity for the use by electric apparatus and/or the Mains. Said wind mill is further comprising a selection and controlling device, wherein said device is selecting the amount of electric power to direct use for electric apparatus and/or the Mains, and is controlling process parameters of both conversions: those of wind power into pressurized fluid, and/or pressurized fluid into electricity.

### TECHNICAL FIELD

A wind mill for generating wind power, for the conversion of said wind power into electricity and for conserving gained wind power for later use, said wind mill us comprising a rotor or a propeller which is communicating with a 1^{st} axle, for generating a turning moment for said 1^{st} axle, said rotor or propeller is rotating in a flow of wind, further comprising a pump, which is communicating with said 1^{st} axle.

A flow optimiser for a wind mill, wherein the rotor of said wind mill is positioned within the building for which electricity is being generated, turning around an axle, said rotor is communicating with channels for canalizing said wind flow, to and from said rotor, said channels are communicating with a turnable channel, turning around an axle, and positioned partly outside the building,

### BACKGROUND OF THE INVENTION

This invention deals with the conversion from wind power to electric power in general, centrally where a wind mill is standing on the country side, or done decentrally, e.g. per household or per unit of staying.

There are a number of current problems by said conversion, such as such as noise of wind mill propeller blades, low efficiency of the use of wind mills for generating electricity by central storage of electric power, the visual pollution of landscapes and the high investments of classic wind mills, due to its sizes and geographical place (e.g. at sea). The reason why said classic wind mills are using electrical devices for direct conversion of wind power into electricity, and storage of electricity in batteries, may be, that most of the owners of said wind mills are electricity providers.

Wind mills which are using a compressed fluid (e.g. air, N₂) as storage medium of conversed windpower, and thereafter convert the power of said storage medium into electricity are rare, even it has been confirmed that the efficiency is better than the direct conversion of wind power into electricity.

### OBJECT OF THE INVENTION

The object is to provide solutions for current problems in the conversion from wind power to electric power.

### SUMMARY OF THE INVENTION

In the first aspect, the invention relates to a motor, wherein:

said wind mill is communicating with a Motor, the last mentioned is comprising a pump with a conical chamber for pressurazation of a medium, a pressure storage vessel, a self-propelled actuator piston positioned in a conically shaped wall of a chamber, and an axle, the last mentioned is communicating with a dynamo, which is providing electricity for the use by electric apparatus and/or the Mains.

The storage of a compressed fluid, preferably gaseous medium in a pressure storage vessel (e.g. of the Vanderblom Motor: WO 2013/026508) is simple and low cost, and said vessel does not leak. The use of a pump with a conical wall of its chamber may reduce the energy used by approx. 70%. This means that wind mills of approx. ¾ to ½ sized of currently used wind mills are as efficient as wind mills currently used. Or, by keeping the size of a current size of a wind mill, may wind mills become approx. 2-3× more efficient.

The use of said Vanderblom Motor, instead of an hydraulic engine, is processing the conversion of wind power into electricity much more efficiently. Preferable is a Motor using turnable chambers around a fixed actuator piston. For use in a building, is it very fortunate that the Vanderblom Motor is silently functioning.

The use of a flow optimizer may make it possible that even in city buildings wind power may be used decentrally, even the wind conditions are not as good as at sea or on the country side.

The gearbox communicating with a wind mill axle of a classic type wind mill, may be different from a currently used gearbox, as it powers the pump of the Vanderblom Motor, instead of directly the generator.

Said gearbox and pump may in a classic wind mill be positioned in the top of said wind mill, so that tubes may be used as transport channels for pressurized fluid to the pressure storage vessel, the last mentioned being mounted on the foundation of said wind mill.

In the second aspect, the invention relates to a motor, wherein: Said windmill is positioned outside a building, a vehicle or another stationary device or said wind mill is positioned inside a building or is part of a vehicle or a stationary device, wherein said wind mill is additionally comprising a flow optimiser, for optimising the wind flow towards and from said rotor, wherein said wind mill is communicating with said flow optimizer.

The use of a flow optimizer may make it possible that even in a city buildings wind power may be used decentrally, even the wind conditions are not as good as at sea or on the country side.

The advantage of the use of a storage type with a compressible fluid (e.g. a no problem gaseous medium as air, N₂)

is, that it is low cost, and it does not leak, and can thereby be used with peace in mind. E.g. the pressure storage vessel+equipment for H₂ (for the use with a burning cell) in a house costs approx. CHF 650K (!).

When there is no wind, or much too less wind or if necessary for any other reason, said Motor can be shut down by closing a valve between the inlet of the actuator piston and the pressure storage vessel; an alternative mode to let such Motor drive on the currently stored amount of compressed fluid, until a certain minimum pressure has been reached in said pressure storage vessel.

If there is wind enough, the Motor can drive and electricity can be produced—for the house and/or the Mains: said valve is open. Depending on the varying requirement of amounts of electricity is it possible to vary the speed of said Motor, so that the necessary amount of Kwh (Kilowatt hour) can be delivered to the house—it may also be possible to deliver constantly, and guide superfluous electricity to the Mains.

A preferred economic strategy for running said conversion of wind power to electric power may be to let said Motor run with such a speed, that no wind power is lost for the conversion of wind power into compressed fluid—superfluously compressed fluid may be stored in said pressure storage vessel, while said Motor is running with such a speed that it is providing the required amount of electricity for the house, while the exit to the Mains is closed. Currently may it be expensive to supply electricity to the Mains!

As a result may it be necessary to have a computer running said conversions economically.

In the third aspect, the invention relates to a motor, wherein:

said device is communicating with the wind through a flow optimiser, adapting the direction of the flow of the wind to the direction of the inlet channel of said device in order to enhance the efficiency of said device.

A device, such as a propeller, where its centre axis of its axle is approximately aligning the flow of the wind, or a device comprising two or more blades wherein its axle stands perpendicular the flow of the wind, are normally build outside buildings, generating noise and visual pollution—the last mentioned device type, a rotor, will be functioning independently of the direction of the wind, which, if situated on buildings with flat roofs may not to generate very much visual pollution. This latter type of device may be preferred, specifically also because a flat roof allows a certain diameter, giving a higher torque, thus a higher power.

However, most of the building do not have a flat roof, but a V-shaped roof, and that does not allow devices as the last mentioned as preferred, because it is generating visual pollution. Instead such a device may be build inside said roof, in e.g. the attic. This may reducing its efficiency, because houses are normally not build, so that a 360° rotation of said building is possible, as it cannot adapt the direction of its entry channel to the changing wind directions. Instead flow optimisers may be build in the roof, preferably in both surfaces of the V-shaped-roof. That means that said devices may have a slightly reduced torque on the axle

In a fourth aspect the invention relates to a device, which is comprising an actuator piston A motor, wherein it comprises attached hereto a piston-chamber combination comprising a chamber which is bounded by an inner chamber wall, and comprising an actuator piston inside
said chamber to be engagingly movable relative to said chamber wall at least between a first longitudinal position and a second longitudinal position of the chamber, said chamber having cross-sections of different cross-sectional areas and different circumferential lengths at the first and second longitudinal positions, and at least substantially continuously different cross-sectional areas and circumferential lengths at intermediate longitudinal positions between the first and second longitudinal positions, the cross-sectional area and circumferential length at said second longitudinal position being smaller than the cross-sectional area and circumferential length at said first longitudinal position,
said actuator piston comprising a container which is elastically deformable thereby providing for different cross-sectional areas and circumferential lengths of the piston adapting the same to said different cross-sectional areas and different circumferential lengths of the chamber during the relative movements of the piston between the first and second longitudinal positions through said intermediate longitudinal positions of the chamber,
the actuator piston is produced to have a production-size of the container in the stress-free and undeformed state thereof in which the circumferential length of the piston is approximately equivalent to the circumferential length of said chamber at said second longitudinal position, the container being expandable from its production size in a direction transversally with respect to the longitudinal direction of the chamber thereby providing for an expansion of the piston from the production size thereof during the relative movements of the actuator piston from said second longitudinal position to said first longitudinal position,
the container being elastically deformable to provide for different cross-sectional areas and circumferential lengths of the actuator piston,
   wherein
   the combination comprises means for introducing fluid from a position outside said container into said container, thereby enabling pressurization of said container, and thereby expanding said container,
   a smooth surface of the wall of the actuator piston, at least on and continuously until nearby its contact area with the wall of the chamber, thereby displacing said container from a second and a first longitudinal position of the chamber,
   said actuator piston is self-propelled, or is fixed, while said chamber is rotating, the combination comprises means for reducing the volume of said container from a position outside said container by exiting fluid from said container, thereby depressurizing said container when moving from a first to a second longitudinal position,
   further comprising a pump comprising a chamber which is bounded by an inner chamber wall, and comprising a piston in said chamber to be engagingly movable relative to said chamber wall at least between a first position and a second position of the chamber, said chamber having cross-sections of different cross-sectional areas at the first and second positions, and at least substantially continuously different cross-sectional areas and circumferential lengths at intermediate positions between the first and second positions, the cross-sectional area at said second position being smaller than the cross-sectional area at said first position, and further comprising a pressure storage vessel, according to WO 2013/026508 A1.

Specifically efficient is the use of said motor with a circular chamber, while the use of a storage vessel of a compressed fluid, such as air or N₂ is very efficient—this means of storage has no leakages, such as a battery has, and the costs of the pressure storage vessel are much lower than that of batteries.

In a fifth aspect the invention relates to a device comprising blades which allows its axle to turn in one direction, independent of the direction of the flow through said blades.

On the market are blade types for said device, which can turn its axle in one direction, even the flow of the medium is in one direction of the opposite direction. In that way the inlet channel of said device may be positioned at one side of the V-shaped roof, and the outlet channel may be at the other side of the V-shaped roof.

In a sixth aspect the invention relates to the inlet channel is positioned at one side of the roof, while the outlet channel is at the other side of the roof.

On the market are blade types for said device, which can turn its axle in one direction, even the flow of the medium is in one direction of the opposite direction. In that way the inlet channel of said device may be positioned at one side of the V-roof, and the outlet channel may be at the other side of the V-roof. Thus, depending of the direction of the wind, the inlet channel may at another point of time be an outlet channel, and the other way around.

In a seventh aspect the invention relates to a flow optimiser, which is comprising a turnable channel.

The flow optimiser may comprising a turnable channel, turnable approximately 180°, which may be the whole angle of said roof. Said flow optimiser may be positioned in the inlet channel. If designed well, it may be very well suiting local laws for buildings, not causing visual pollution and therefore be allowed.

Said optimiser, and thus a turnable channel, may also be present in the outlet channel.

In a eighth aspect the invention relates to said turnable channel, the direction of its opening in relation to the direction of the flow of the wind is controlled by a computer program, so that the flow is optimised.

The sensor for the flow direction of the wind is present nearby the inlet channel, outside, while a separate sensor is present in the inlet channel ahead of the rotor (seen in the direction of the wind flow) with the blades. A third sensor is present just behind rotor (seen in the direction of the wind flow) in the outlet channel. A fourth sensor is present nearby the outlet channel, outsite, measuring the wind direction at that part of the roof

In a ninth aspect the invention relates to a computer program, which is controlling the opening of the current inlet- and outlet channel, in order to optimise the flow through said blades of the rotor and the direction of the wind on each side of the building.

This part of said computer program optimizes the whole flow through the blades of the rotor. The central axes of the both turnable channels, one on each side of the roof, may be parallel or not.

In an tenth aspect the invention relates to the inlet- and outlet channels of which the shape of the wind flow through said channels be optimized by having changed the shape of the bounded walls of said channels.

When the shapes of the boundary of said channels are being changed, e.g. by actuators, than the flow through said channels may remain laminar, thus with lowest friction. If the wind speed is low, the walls of the channels may be chaining form, so that only the approximately half of the rotor is being influenced by the wind flow—the reduced area perpendicular said flow will result in a higher speed (Bernoulli's law), which still makes the rotor to turn around, generating electricity and/or pressurized gaseous medium.

When the rotor, having an axle of which centre axis is positioned perpendicular the wind flow through said channels, only can turn in one direction, and when the wind is changing direction (<180°—the turnable inlet channel remains inlet channel), the adaptation of the shape of said boundaries of said channels may be mirrored at the transitions of the turnable channels to the channels (that is a lot of work to be done by said actuators). If the wind is changing direction >180°—the turnable inlet channel becomes the outlet channel and vice versa), than again may said adaptation be mirrored, not only for said transitions, but as a whole for all channels. This embodiment has the best efficiency, but may be pricey.

A more less expensive solution is, when said rotor may turn in two, opposite directions. The mirroring is necessary only to the transitions, by wind direction changes amounting 0°-360°.

When using a rotor, of which centre axis is positioned in the direction of the wind flow through said channels, and which can turn in one direction irrespective the direction of the wind through it, the adaptation of the shape of the boundary of said channels may be unnecessary—however, the efficiency may be reduced in relation to the above mentioned embodiments.

In a eleventh aspect of the invention relates to an optimized transition between the turnable channel and the inlet- and outlet channels, by rounding off any disruption and by sealing said transition.

Disruptions gives non-laminar flow, resulting in friction, and energy loss. Sealing the transition may the most important aspect, as a little leak gives a disproportionate reduction of internal pressure.

As a second use of this device, may the pressure storage vessel of said device be used for generating power to a pressure storage vessel of an external motor according to WO 2013/026508 A1, which may be build in a car, owned by the family of the house, which is provided with said device.

In a twelfth aspect of the invention relates to a feasibility study on the possible reduction of building costs of a green wind mill in relation to a classic wind mill: thus a reduction of investment costs for building a wind mill which is generating a specific amount of KWh.

When using a pump piston according to WO 2017/089852 A1 in a conical chamber according to e.g. WO 2013/026508 A1, FIG. 21A, a reduction of the energy used to drive said pump piston to providing a certain pressure of the medium in said conical chamber, while moving sealingly in said chamber, is approx. 50-60% in relation to a pump where a classic piston is moving in a straight cylinder. Said last mentioned embodiment can be compared regarding the use of energy, with the currently used wind mill embodiments, where a generator has been integrated in the driving axle of the propeller of said classic wind mill.

The frontal area A₁ (m²) of a classic windmill with a horizontal axel is related to the wind mill power P₁ (KWh or MWh), with a propeller diameter d₁ (m). What is the size of the diameter d₂ of the propeller of a green wind mill with a comparable or even power, when we disregard the conversion of wind mill power into electricity? With a 50% reduction: d₂=0.71 d₁ and with a 60% reduction: d₂=0.63 d₁

A classic wind mill with a gross power of 4.5 MWh, having a propeller with a diameter d₁=120 m, and a height of the horizontal center axis of 100 m, can be exchanged by a green wind mill:
By 50% reduction: a wind mill (which in a classic configuration would be gaining gross 2.2 mWh), having a propeller diameter of 85 m, and a center axis height of approx. 70 m;
The building costs would likely be a bit more than 50% of the costs of a classic wind mill configuration;
By 60% reduction: a wind mill (which in a classic configuration would be gaining gross 1.8 MWh), having a propeller diameter of 76 m, and a center axis height of approx. 65 m;
The building costs would likely be bit less than 50% of the costs of a classic configuration.

The building costs of a green wind mill will be higher than mentioned above, because of the pressure storage vessels, and the Motor, which are not used in a classic configuration. However, the batteries of the electric storage may financially be balance that of said pressure storage vessels, as only approx. 20 Bar fluid pressure may be gained by said pump, so that a number of pressure storage vessels may have to be used. Thus, the extra costs of a green configuration in relation to a classic configuration may be solely the Motor.

A thirteenth aspect of the invention relates to the feasibility study on the possibility to have a wind mill in-house for providing electricity for the household living in said house.

The need for electric power for 1 household is approx. 1200 KWh per month.

A wind mill type with a classic configuration as e.g. a Savonious, is not efficient E=E(u/V) (E=efficiency factor for a wind mill design, V=windspeed, u=speed of any area of a wind mill) enough to result in appropriate sizes for building said wind mill inside a normally sized one family house.

Even an efficient hybrid type wind mill having a classic configuration, like the “eggbeater”, results in too big sizes: diameter ø2.8 m for E=0.4.

Firstly when a Vanderblom Motor is being used, which reduces the need for power generating by approx. 50%, said sizes become appropriate: diameter ø1.96 m, when the rotor of an “eggbeater” is being used.

And again, the use of said flow optimizer for an inhouse wind mill will definitely enhance efficiency of generating electricity.

In a fourteenth aspect of the invention relates to the feasibility study of adding the green configuration to existing wind mill with a classic configuration.

The only problem with the above mentioned conversion of configuration may be lack of space, which is necessary for the pressure storage vessels and the Motor, when wind mills with a classic configuration are being set up in closely side by side rows.

In a fifteenth aspect of the invention relates to some important aspects of the combination of an inside wind mill in a house, solar cells on the roof of said house, and an electric car in the garage.

Said combination may give a household a self providing energy system, as wind and sun in time have complementary providing energy.

In order that electric cars indeed save CO₂-emissions, when connected to the house hold energy system (and NOT the Mains, which still may get electricity from burning cokes), the electric systems for both sun cells and the wind mill, need to be set to the electric system of said car or the other way around. It is already existing, but only as a one-off system. CO₂-emission legislators and car manufacturers may give this issue a much higher priority, now we still are in the start phase of going electric.

### BRIEF DESCRIPTION OF THE DRAWINGS

In the following, preferred embodiments of the invention will be described with reference to the drawings wherein:

FIG. 1.1 shows schematically a front view of a house with a V-shaped roof.

FIG. 1.2 shows a side view of the house of FIG. 1.1.

FIG. 1.3 shows a top view of the house of FIG. 1.1.

FIG. 2 shows a scaled up to view of the FIG. 1.3.

FIG. 3.1 shows schematically the computer control of the flow optimiser.

FIG. 4.1 shows the internal channels of the flow optimiser, where the axle of the rotor, which is communicating with a generator directly of with the pump of the Vanderblom Motor, is positioned perpendicular to the flow through said rotor, while the flow of the wind is coming from the left top of the figure.

FIG. 4.2 shows the internal channels of the flow optimiser of FIG. 4.1, when the wind is coming from the right bottom of the figure.

FIG. 4.3 shows the construction details of the turnable channel of FIG. 4.1.

FIG. 4.4 shows the details of the flow optimiser, where the centre line of the axel of the rotor, which is communicating with the pump of the Vanderblom Motor, is in line with the flow through said rotor—a preferred version of this rotor will be able to turn in one direction, irrespective the direction of the flow.

FIG. 4.5 shows the construction details of the flow optimiser of FIG. 4.4.

FIG. 4.6 shows an “eggbeater” hybrid windmill exchanging the rotor 58 of FIG. 4.4, within the details of FIG. 4.4.

FIG. 5.1 shows schematically the main functions of the conversion of wind power for a wind mill, positioned in a e.g. building, into electricity, using the Vanderblom Motor.

FIG. 5.2 shows a similar overview of functions of the conversion (and storage) of windpower for a wind mill, positioned on e.g. the country side, of wind power into electricity, using the Vanderblom Motor.

FIG. 6 shows schematically the Vanderblom Motor according to an embodiment with a crankshaft of the Consumption Technology (based on FIGS. 11A and 11B of WO 2013/026508), where a turnable axle driven by wind power is driving the pump of said motor, which is communicating with a pressure storage vessel—an actuator is running on pressurized gas, running through a crankshaft the outgoing axle, which is communicating with a generator, which powers the household with electricity, while auxiliary electricity can be send into the Mains.

FIG. 7 shows schematically the Vanderblom Motor motor according to an embodiment of the Enclosed Space Volume Technology (based on FIG. 11G of WO 2013/026508), where a turnable axle driven by wind power is driving the pump of said motor, which is communicating with a pressure storage vessel—an actuator, working on pressurized gas is running the outgoing axle, which is communicating with a generator, which powers the household with electricity, while auxiliary electricity can be send into the Mains.

FIG. 8A shows schematically the Vanderblom Motor according to en embodiment of the Enclosed Space Volume Technology (based on FIG. 91A of WO 2013/026508) of a fixed actuator piston in a rotating chamber.

FIG. 8B shows schematically the Vanderblom Motor according to en embodiment of the Enclosed Space Volume Technology (based on FIG. 91B of WO 2013/026508) of an fixed actuator piston in a rotating chamber.

FIG. 9A shows schematically a 3-cylinder Vanderblom Motor according to an embodiment of the Enclosed Space Volume Technology (based on FIG. 93A of WO 2013/026508 with fixed actuator piston in rotating chambers.

FIG. 9B shows an enlargement of a detail of FIG. 9A.

FIG. 10 shows the schematic configuration of a wind mill standing on the country side, where a Vanderblom Motor is being used.

### DESCRIPTION OF PREFERRED EMBODIMENTS

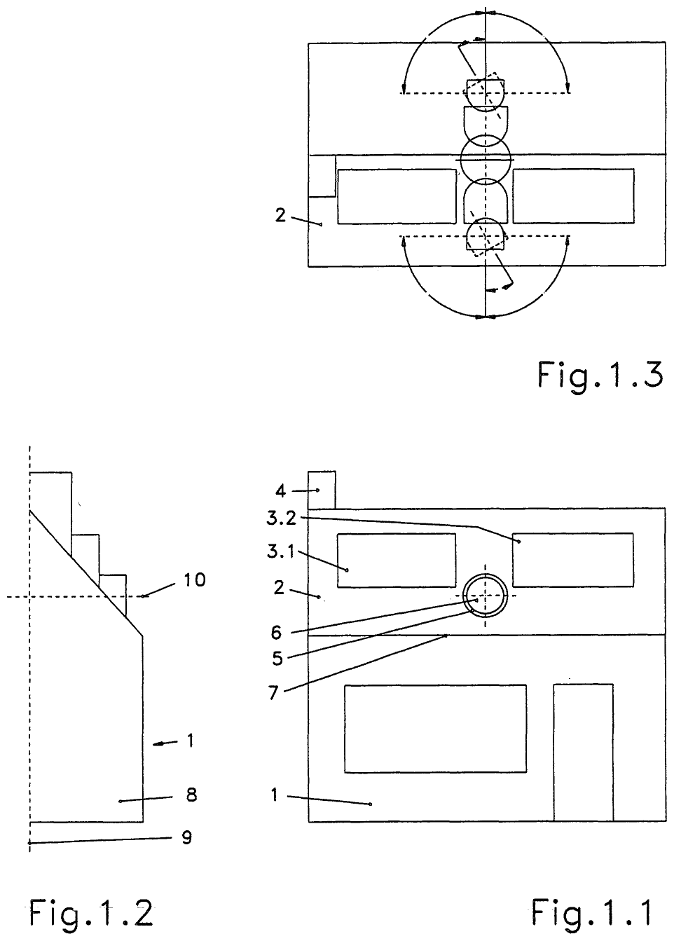

FIG. 1.1 shows schematically a front view of a house 1, comprising a roof 2, with two build up windows 3.1 and 3.2, and a chimney 4. The entry 5 of an inlet channel 6, said entry 5 shown being perpendicular the width axis 7 of the house 1.

FIG. 1.2 shows the side 8 of the house 1, with the centre axis 9 of the house 1 and the centre axis 10 of the inlet channel 6.

FIG. 1.3 shows the top view of the roof 2.

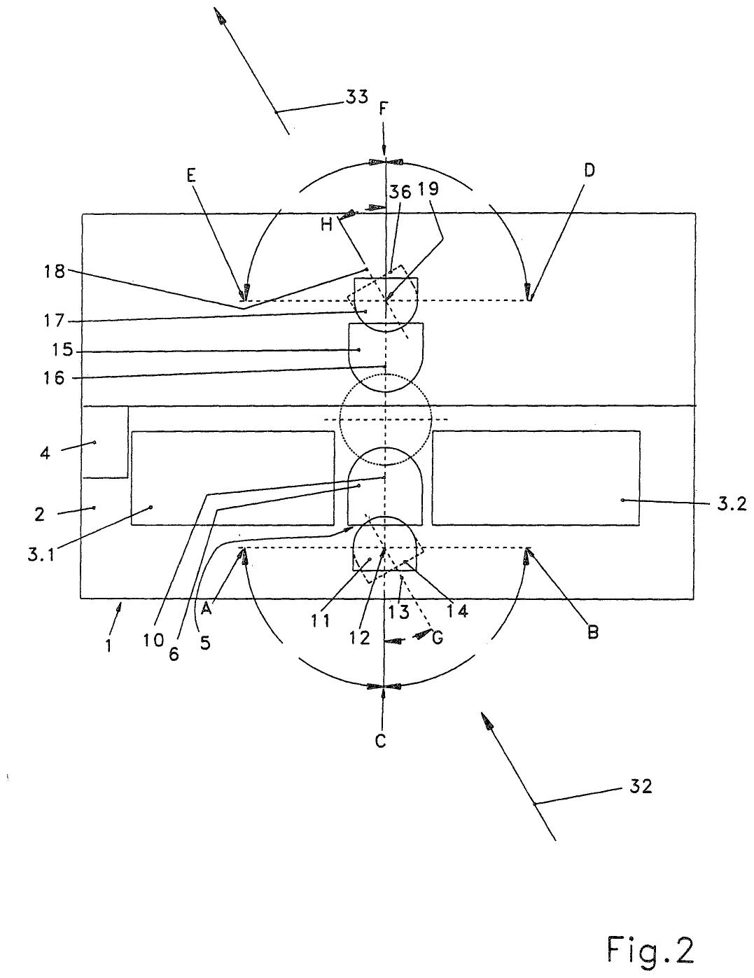

FIG. 2 shows a scaled up top view of the house 1 of FIG. 1.3. The top of the build up windows 3.1 and 3.2. The chimney 4. The inlet channel 6 and its entry 5. The turnable channel 11, which may turning +90° (ref A) and −90° (ref. B) from its 0-position (ref. C) around an axle 12, being its centre axis 13 in line with the centre axis 10 of the inlet channel 6. The turnable channel 11 has an opening 14. The turnable channel 11 is shown turned to a −30° position (ref G) as an example.

On the other side of the roof 2, the is the partly mirrored build of the inlet channel 6 being the outlet channel 15, with centre axis 16 with a turnable channel 17, with centre axis 18. The turnable channel 17, which may turning +90° (ref D) and −90° (ref E) from its 0-position (ref F) around an axle 19. The turnable channel 17 is shown turned to a +30° position (ref H) as an example, and related to the −30° position (ref G) of the turnable channel 11.

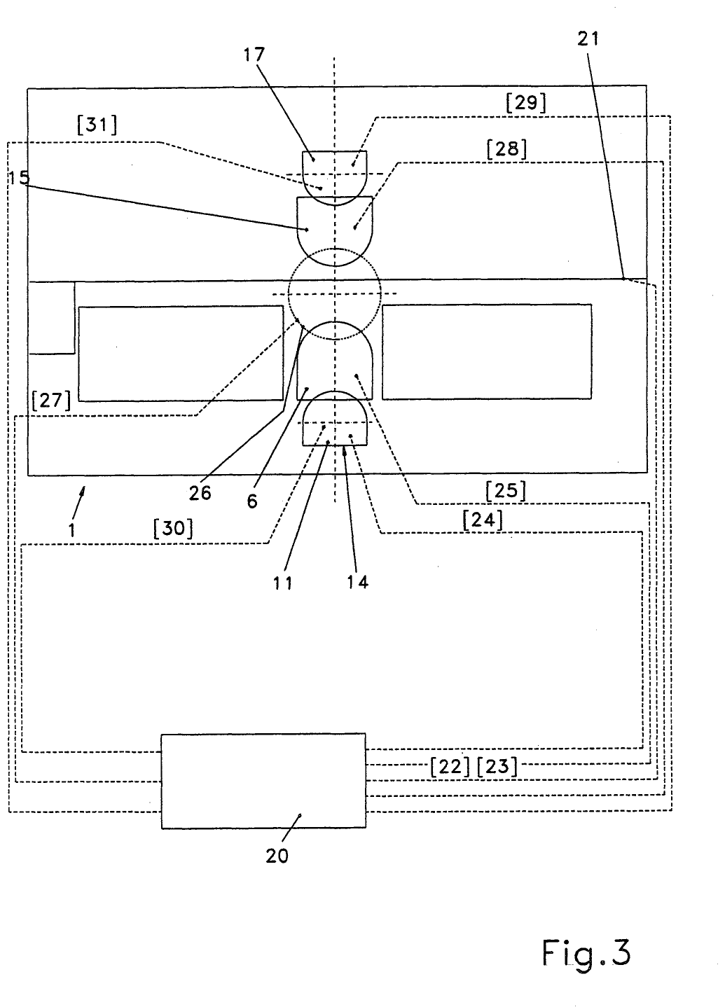

FIG. 3 shows the top view of the house 1. The computer 20 with measuring sensors 21 on top of the roof for wind speed [22] and wind direction [23], the position [24] of the opening 14 of the turnable channel 11, the wind speed [25] ahead of the rotor 26 (schematically shown as a circle), the speed [27] of the rotor 26 in the inlet channel 6, the wind speed [28] in the outlet channel 15, and the wind speed [29] in the turnable channel 17, the position [30] of the turnable channel 11, and the position [31] of the turnable channel 17. The activation signals for changing the position of both turnable channels may be done using the sensor lines [30] and [31], respectively.

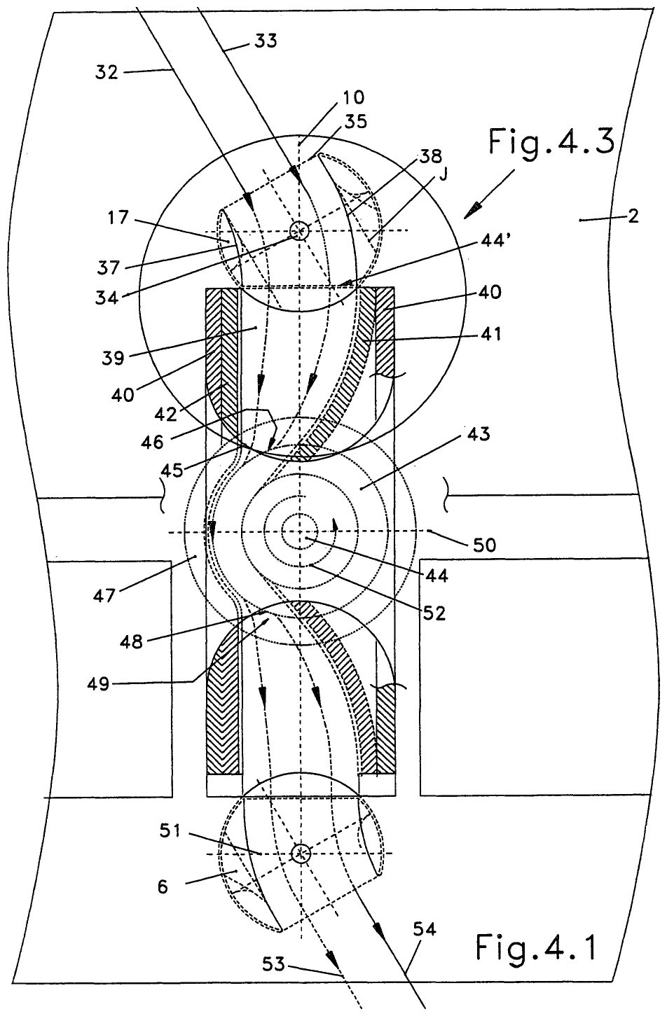

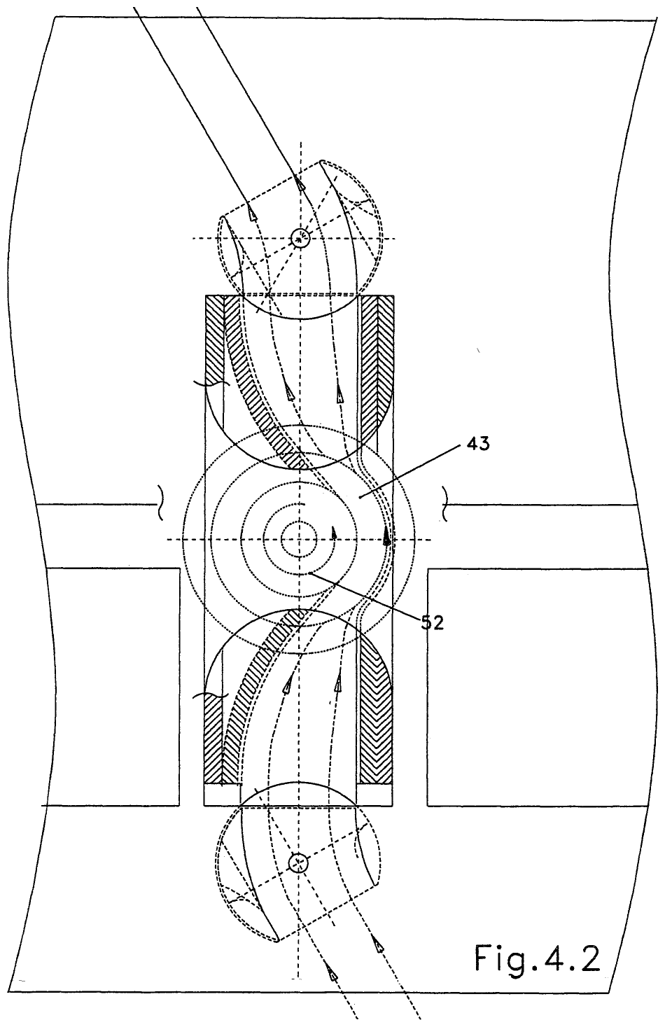

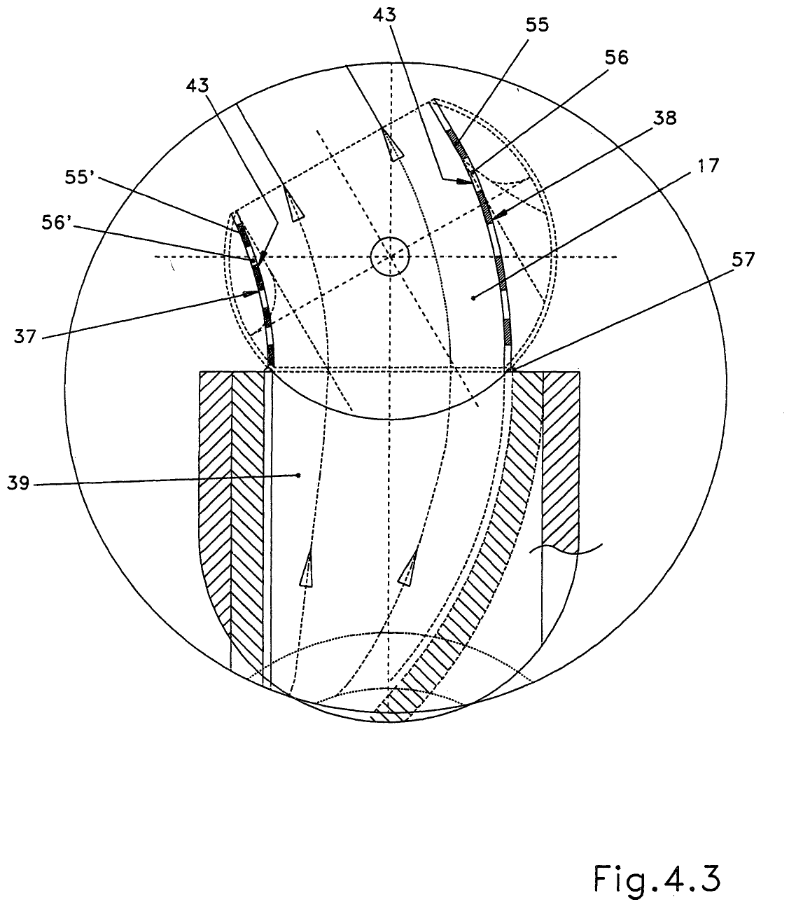

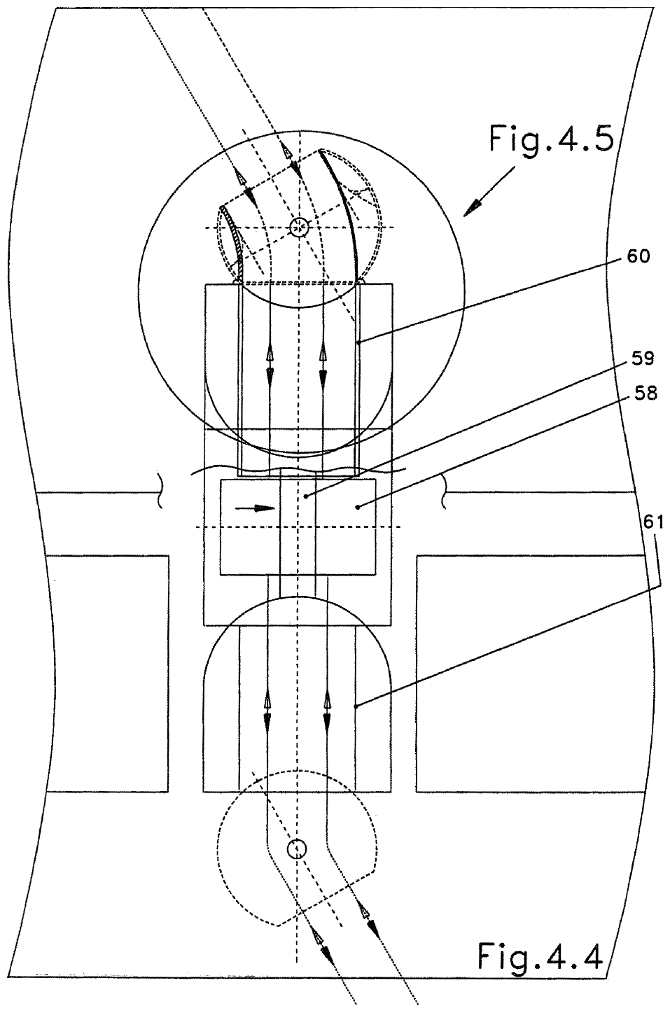

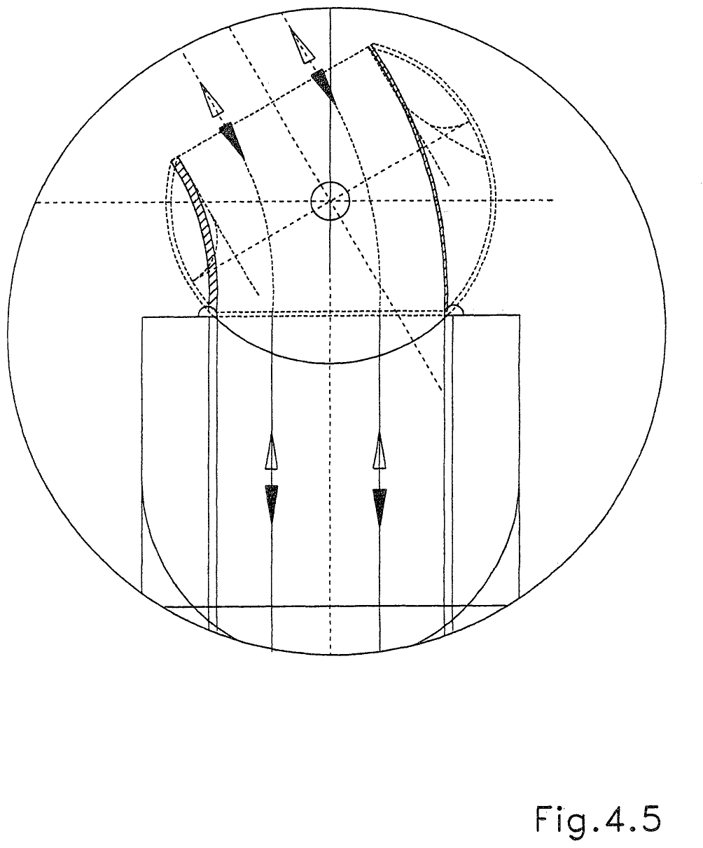

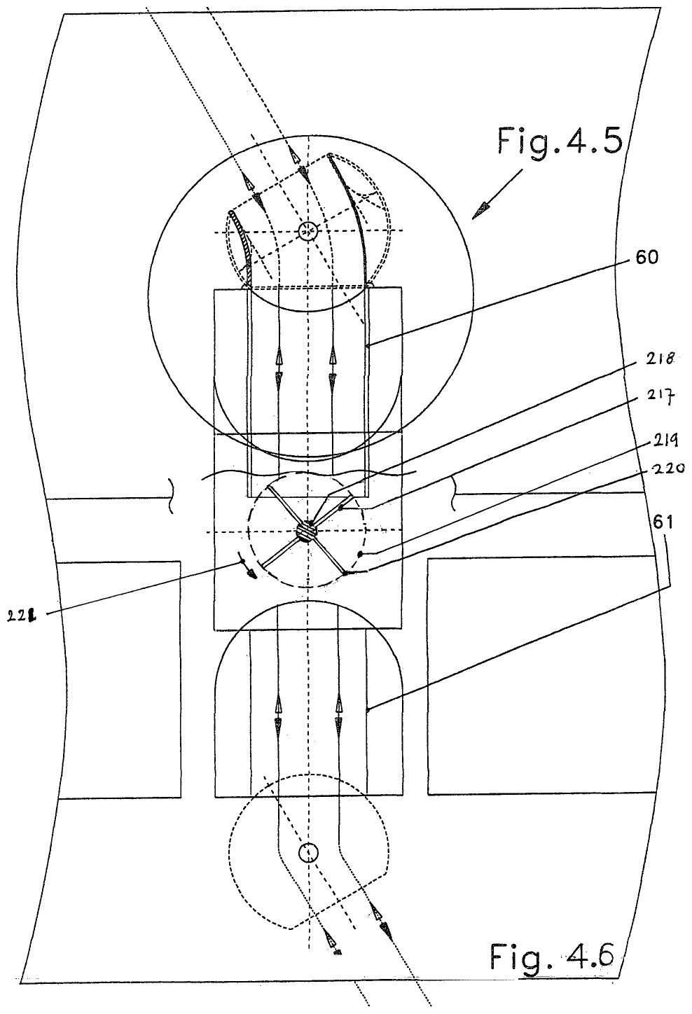

FIG. 4.1 shows details of the flow optimiser, in preferred version. It can generate electricity, even by very low wind flows, due to the use of Bernoulli law.

The incoming wind, schematically shown by two lines 32 and 33, resp. with black arrows, showing the wind direction. The turnable channel 17 is turning around a vertical axle 34. The opening 35 of the inlet of the turnable channel 17, in a preferred position perpendicular the incoming wind (32,33), and the opening 36 of the outlet of said channel 17. In between said inlet and said outlet are the walls 37 and 38, resp. The wall 37 has been decreased in size in comparison to its length J when the turnable channel 17 has a position (not shown) perpendicular to the roof 2. The wall 38 has been increased in length. The channel 39 has stationer walls 40 and movable walls 41 and 42. The rotor 43 is turning anti-clockwise around the vertical axle 44. In order to maximize a laminar flow in the channel 39 from the inlet 44′ and to its outlet 45, the walls 41, 42 have been bent, so that the outlet 45 creates an optimized flow into the inlet 46 of the rotor. The rotor housing 47 is optimizing the flow around said rotor 43. The outlet 48 of said rotor 43 is guiding the flow into the inlet 49 of the channel 6. The rotor is turning anti-clockwise 52 around the vertical axis 10 and the horizontal axis 50. The rest of the construction is a through mirror around axis 50 of the already described construction, while the turnable channel has additionally thereafter to mirror around its horizontal axis 51. The outgoing flow—lines 53 and 54 from the turnable channel 6, shown in a preferred position namely perpendicular the opening 14 of said turnable channel 6.

FIG. 4.2 shows the embodiment of FIG. 4.1, when the direction of the wind flow has been reversed, while said rotor 43 only can turn anti-clockwise, as shown, than the channels 6 and 17 should be mirrored around the vertical axis 10, in relation to the configuration of said channels in FIG. 4.1. When the rotor 43′ additionally could turn clockwise (not shown) than said mirroring would not be necessary—the configuration of said channels of FIG. 4.1 still could be used.

FIG. 4.3 shows the (turnable) channel of the embodiment of FIG. 4.1. The details of the turnable channel of FIG. 4.4 are similar. The walls 37 and 38 are comprising wall parts 55, 55′ and 56, 56′, resp., which are communicating with each other. The wall parts 55 are partly made of a composite material: non-flexible material in the vertical direction of said channel, while a bit bendable in the direction of the wind flow (in all necessary directions of the wind flow), and of a non-flexible parts 56, made of a metal or a durable plastic, so that the last mentioned can be directed in the right direction, thereby guiding the first mentioned flexible/bendable wall parts into the right direction. The last mentioned is done by e.g. EP13075055.7 and EP1405055.5, thereby reducing the use of energy for the optimalisation of the wind flow. The sealing 57 between the turnable channel 17 and the channel 39. The walls 37, 38 bounding the wind flow are thereby made smooth (laminar flow).

FIG. 4.4 shows an embodiment similar to the one shown in FIGS. 4.1, 4.2 and 4.3, whereby the rotor 58 has been exchanged by a type which can turn in one direction, even when the wind flow through it has been reversed. The axle 59 of this rotor type is in line with the flow of the wind. This means that the channel construction can be simplified, as the channels 60 and 61 can be static, that is to say the construction will be functioning with walls of the channels, without changing their form. Also here: smooth flow boundaries.

FIG. 4.5 shows the some details of the construction of the turnable channel of FIG. 4.4. These are similar those shown and treated in FIG. 4.3.

FIG. 4.6 shows an “eggbeater” hybrid windmill (schematically drawn) with blades 217 (exchanging the rotor 58 of FIG. 4.4) within the details of FIG. 4.4. The blades 217 turn the (1^{st}) axle 218. The circle round trajectory 219 of the blade ends 220 The turning direction of said blades 222.

This details of said drawing may not be on the same scale.

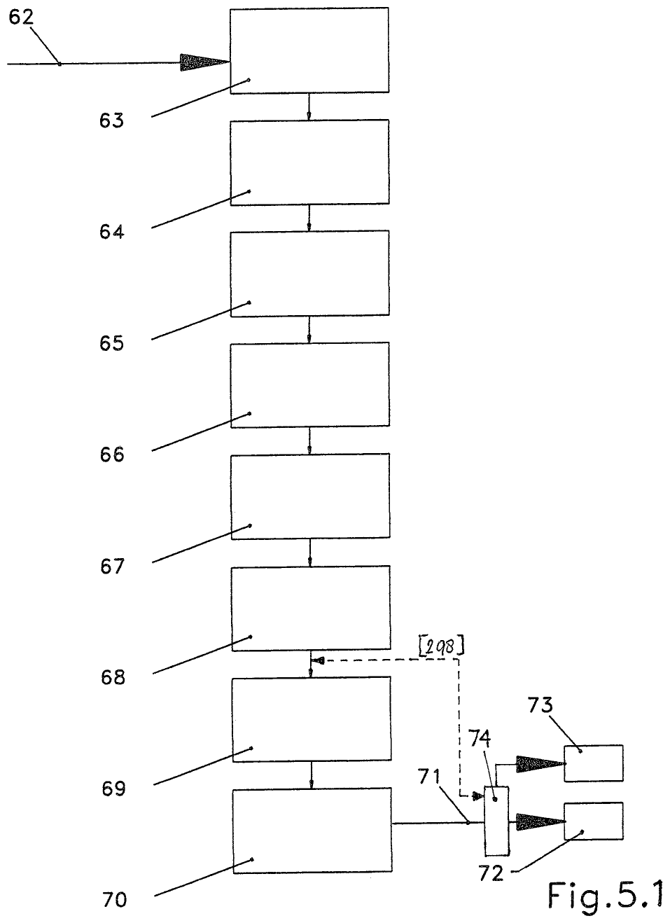

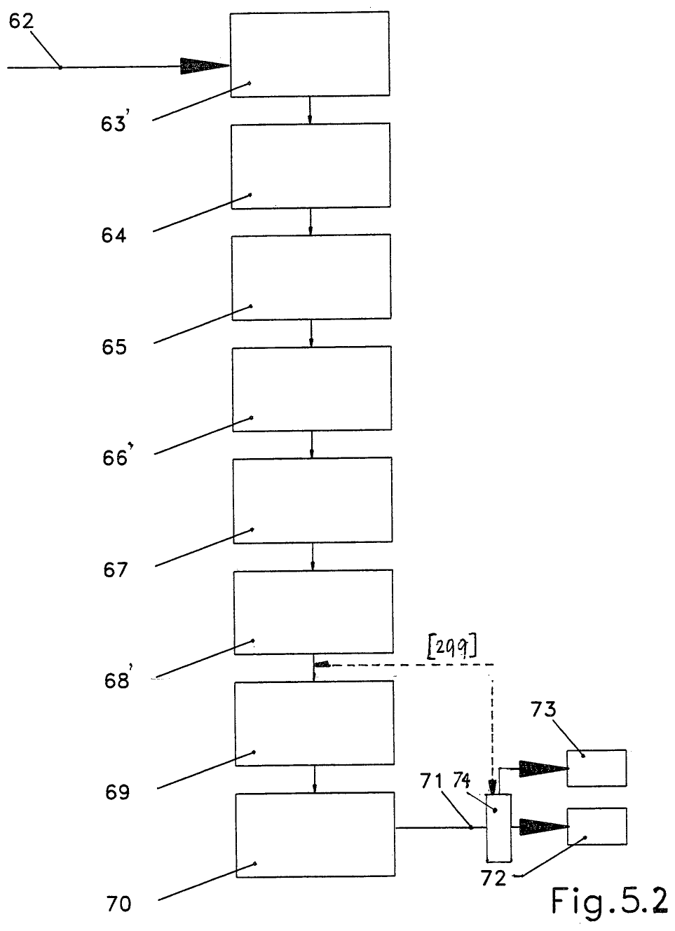

FIG. 5.1 shows schematically the functioning of the conversion of wind power into electricity, using the Vanderblom Motor according WO2012/026508 A1. The arrow 62 represents the incoming wind. The box 63 represents the flow optimiser. The box 64 represents the propeller/rotor 43, 43′,58. The box 65 represents the axle 44, 59 of said propeller/rotor 43, 43′, 58. The box 66 represents the gear box and brakes, resp. The box 67 represents the pump, with(out) a crankshaft, and this may be the pump of the Vanderblom Motor. Box 68 represents the pressure storage vessel of the Vanderblom Motor. The Box 69 represents the self-propelled actuator piston of the Vanderblom Motor. The box 70 represents the generator. The arrow 71 represents an electric power line, while box 72 represents the electric power outlet where said electricity is used in the building, while box 73 represents the electric power outlet to the Mains. All small arrows between the boxes mean that boxes at the beginning and end of an arrow are communicating with each other. Box 74 is a control and switch device which automatically switches the current from box 72 to box 73 if an overflow of power to the building may arise, and vice versa, if lack of power is arising in the building, said device may be computer controlled. Box 74 is controlling the opening and closing of the inlet valve of an actuator piston. FIG. 5.2 shows a similar overview as FIG. 5.1, but now for a classic wind mill outside a building, a vehicle or a device. Some of said boxes of FIG. 5.1 will not be used: 63-70 (incl.), 72 and 73, or in a different way, such as:

box 63′: the wind mill can turn 360° on its base, while the propeller/rotor blades can be tuned,

box 66′: the wind mill has a gearbox and/or a crankshaft (for pump 66),

box 68′: the pressure storage vessel may be a group of such vessels, which may have a different size, communicating with said wind mill.

The devices represented by boxes 63′-67 are situated in the top of a wind mill tower, while boxes 68′-70 are positioned on or around the wind mill foundation. Box 74 is controlling the opening and closing of the inlet valve of an actuator piston.

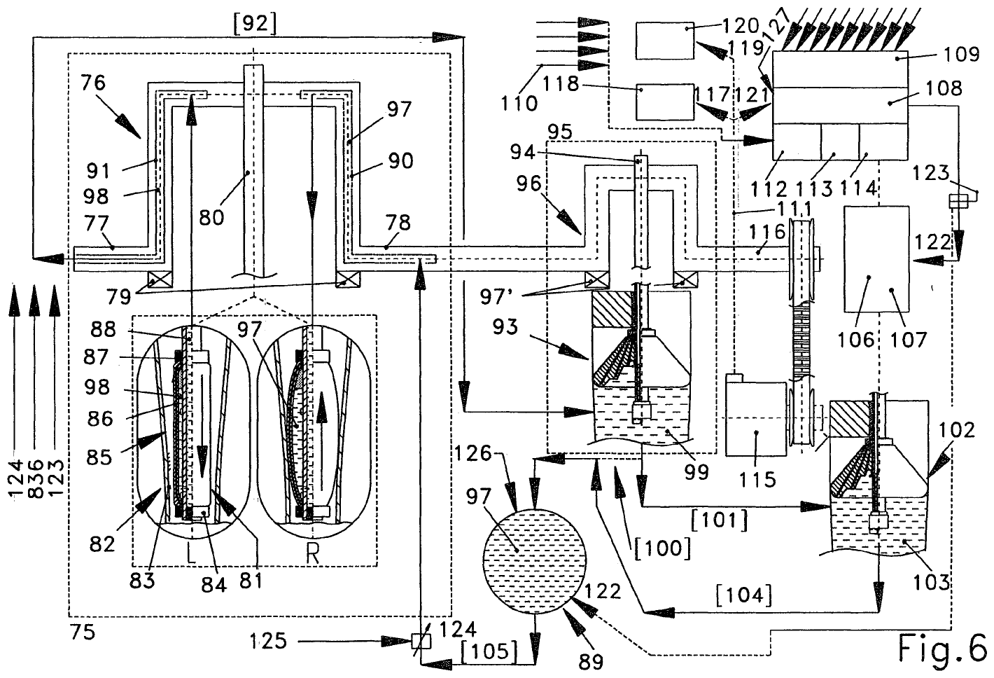

FIG. 6 shows schematically the functioning of the conversion of wind power into electricity, using the Vanderblom Motor, based on the Consumption Technology (CT). On a schematically drawn crankshaft 75 with a U-shaped axle 76, with axle bearings 77 and 78, counterweights 79, is a piston rod 80 assembled, which is on the other side of said piston rod 80, connected to an expandable piston 81, which is shown Left “L” in a movement (arrowed) from first to second longitudinal positions, and Right “R” in a movement (arrowed) from second to first longitudinal positions. Said piston 80 is engagingly movable in a chamber 82 with an internal wall 83. Said chamber 82 has cross-sections with continuously differing cross-sectional area's and differing circumferences, and of which the internal wall 83 has a circumference which is at second longitudinal positions smaller than at first longitudinal positions. The piston 81 has been produced, so that its unstressed production size of the circumference is approximately the size of the circumference of the wall 83 of said chamber 82 at a second longitudinal position. Said piston 81 is connected to the piston rod 80 by a cap 84, while the flexible wall 85 of said piston 83, is comprising reinforcement means 86, and is connected to the piston rod 80 by a slidable cap 87, which can slide over the piston rod 80. When said piston 81 being positioned at a second longitudinal position, and is communicating through its enclosed space 88 with a pressure source, e.g. a pressure (storage) vessel 89, through a second enclosed space 90 in said crankshaft 75 (axel 76), so that said piston 81 is being pressurized by a fluid 97, said piston 81 will begin to move from a second longitudinal position to a first longitudinal piston position, thereby rotating said U-shaped axel 76 around the bearings 77 and 78.

Said movement will change the direction of the movement of said piston 81 into an opposite direction, namely from a first to a second longitudinal piston position. The enclosed space 88 of said piston 81 may then be communicating with a third enclosed space 91 in said crankshaft 75 (axel 76), which is connected through a channel [92] to a piston pump 93 (which may also be instead a rotation pump, e.g. a centrifugal pump), which is connected by a piston rod 94 to a crankshaft 95, with the U-shape axel 96. The crankshaft 95 may be connected to crankshaft 75, so that the rotation of the U-shaped axle 76 results in a rotation of said U-shaped axle 96 with counterweights 97′. Due to said communication is the pressure of the fluid 99 inside said piston 81 be reduced, thus is the circumference of the wall 83 decreased, so that said piston 81 is being able to move from first to second longitudinal piston positions. The fluid 98 is at a reduced pressure (in relation to the pressure of the fluid 97 it had, when the piston was pressurized at a first longitudinal position) is thereafter pressurized by said pump 93 to fluid 103 (of which pressure is of course still less than the pressure of fluid 97) and which is optionally directly transported to said pressure vessel 89 through channel [100], or is preferably transported by channel [101] to another piston pump 102, whereafter said fluid 103 is being pressurized in said pump 102 into fluid 97, and thereafter transported through channel [104] to the pressure (storage) vessel 89. It may also be possible to repressurize said pressure storage vessel 89, through a hose 126, which is communicating with a pressure source. From pressure storage vessel 89 is fluid 97 transported to the second enclosed space 90, through channel [105]. The crankshaft 75 may be connected to a flywheel 123 (not shown), and a gearbox 124 (not shown)—said gearbox 124 may be using Fluid Dynamic Bearings in order to reduce friction. The crankshaft 96 of the piston pump 93. The alternator 115 is communicating with the main axle 116 by means of a drive belt, and is providing the building 118 with electricity through connection 111-117. Additionally it is charging the battery 108 through connection 111-121. And superfluous electricity is send to the mains 120 through connection 111-119. It may also be that this battery 108 is charged by an external electrical power source 127 through e.g. a cable. The wind power 110, represented by arrows is coming through the flow optimiser 112 to the rotor 113, to the axle 114, and through the gearbox/brakes 107 to the crankshaft 106 and finally to the pump 102. Said pump 102 is communicating with the pressure storage vessel 89 through line 104. The motor may start without using a starter motor (not shown), but just by opening up the reduction valve 124, in the channel [105]. Opening this reduction valve 124 more up causes the crankshaft 76 to rotate more quickly, screwing the reduction valve 124 down causes the crankshaft 76 to rotate slower. Closing the reduction valve 124 completely will stop the motor. The speeder 125 is communicating with the reduction valve 124. Reference 75 is a device comprising a crankshaft 76, a piston rod 80, a chamber 82 and an actuator piston 81. Reference 95 is a repressuration stage comprising a crankshaft 96 and a pump 93. Reference 154 is a clutch (not shown).

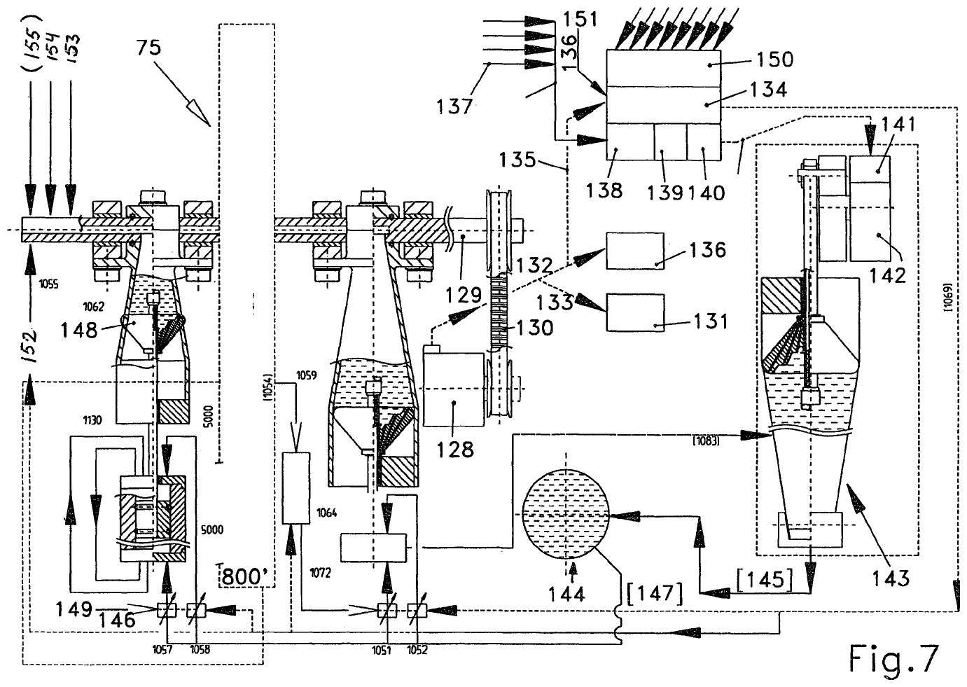

FIG. 7 shows a schematically drawn preferred embodiment of said Motor in said wind mill in a building, based on FIG. 11I of WO 2013/026508 A1. The principle of the ESVT-version (ESVT is an abbreviation of Enclosed Space Volume Technology) has been disclosed the said WO-document—we will only treat here the specific aspects related to the subject matter of this invention.

The alternator 128 is communicating with the main axle 129 by means of a drive belt 130, and is providing the building 131 with electricity through connection 132-133. Additionally it is charging the battery 134 through connection 132-135. And superfluous electricity in said building is send to the mains 120 through connection 132-136. It may also be that this battery 134 is charged by an external electrical power source 151 through e.g. a cable 136. The wind direction 137, represented by arrows is coming through the flow optimiser 138 to the rotor 139, to the axle 140, and through the gearbox/brakes 141 to the crankshaft 142 and finally to the pump 143. Said pump 143 may comprise a long-life pump piston according to WO 2017/089852A1. Said pump 143 is communicating with the pressure storage vessel 144 through channel [145]. The motor may start without using a starter motor (not shown), but just by opening up the reduction valves 146, in the channel [147]. Opening up said reduction valve 146 more up causes the piston 148 to translate more quickly (and the crankshaft in 75 (FIG. 6) to rotate quicker), and vice versa. Closing the reduction valve 146 completely will stop the motor. The speeder 149 is communicating with the reduction valve 146. The solar cells 150.

FIG. 8A shows one circular chamber 156 (over 360°) which is rotating anti-clockwise around an axle 157, and is suspended by 3 spokes 158. Said spokes 158 are shown in a different cross-section than the cross section of the connecting rod 159. A piston 160 is positioned near a first circular position in said circular chamber 156. Said piston 160 is preferably fixedly positioned, by a connecting rod 159, the suspension of the last mentioned, the hub 161, is fixedly mounted on said axle 157 by teeth and corresponding grooves (please see FIG. 8B), which take the reaction forces from the circular chamber 156 on the piston 160. Between the hub 161 of said spokes 158 and said axle 157 is a bearing 162, which may be fixedly mounted onto the hub 161 of said spokes 158 by an appropriate fit, enabling the hub 161 of said spokes 158 to turn around said axle 157. The belt 163, turning near the edge of the chamber housing 164, is running according the direction of the rotation of said chamber 156. The centre axis 165.

FIG. 8B shows a detail of the assembling of the connecting rod 159 and the axle 157. The hub 161 of the spokes 158 is comprising the bearing 162, which is with an appropriate fit turning together with the turning hub 161 of the spokes 158. No valve function is is arranged here, because the bearing 162 is belonging to a different cross-section than the one comprising the channels 172 and 173, of the wall of the axle 157 and the wall of the upper part 161-1 of the hub 161, resp. The hub 161 of the connecting rod 159 is comprising of two parts: upper part 161-1, which is connected to the connecting rod 159, and the bottom part 161-2. Said upper and bottom part are bolted together by bolt 166, which additionally bolts the connection rod 159 to the hub 161. The spring washer 167 and the washer 168. The hub 161 is comprising grooves 169 fitting into teeth 170. There is a constant communication possible between the channel 171 of said axle 157 to the inside of the piston 160, through the channel 172 of the wall of the axle 157, channel 173 through the wall of the upper part of the hub 161-1 and the channel 174 through the connecting rod 158. The centre axis 165. The channel through the extension rod is not shown—please see FIG. 90C (WO 2013/026508). Due to the constant communication, the use of an ESVT system is preferable, specifically when more than one chamber is applied on one axle, and the use of a CT system (′CT′ is an abbreviation of Consumption Technology) is optional.

All of the solutions for a combination with the CT—and/or ESVT pressure management which complied to the embodiments of FIGS. 90A-D (WO 2013/026508) are also applicable for the embodiments of FIGS. 8A and 8B. Not shown, but only mentioned is a chamber, with 4 sub-chambers, comprising 4 pistons, based on the configuration shown in FIGS. 8A and 8B and alike FIGS. 90I,J (WO 2013/026508). Said chamber is rotating around an axle, of which centre axis is going through the centre point of the centre line of said circular chambers. The space within each piston is constantly communicating through channels (enclosed spaces) in each of the 4 extension- and connecting rods with the channel in said axle, and this configuration is preferably functioning with the ESVT—system.

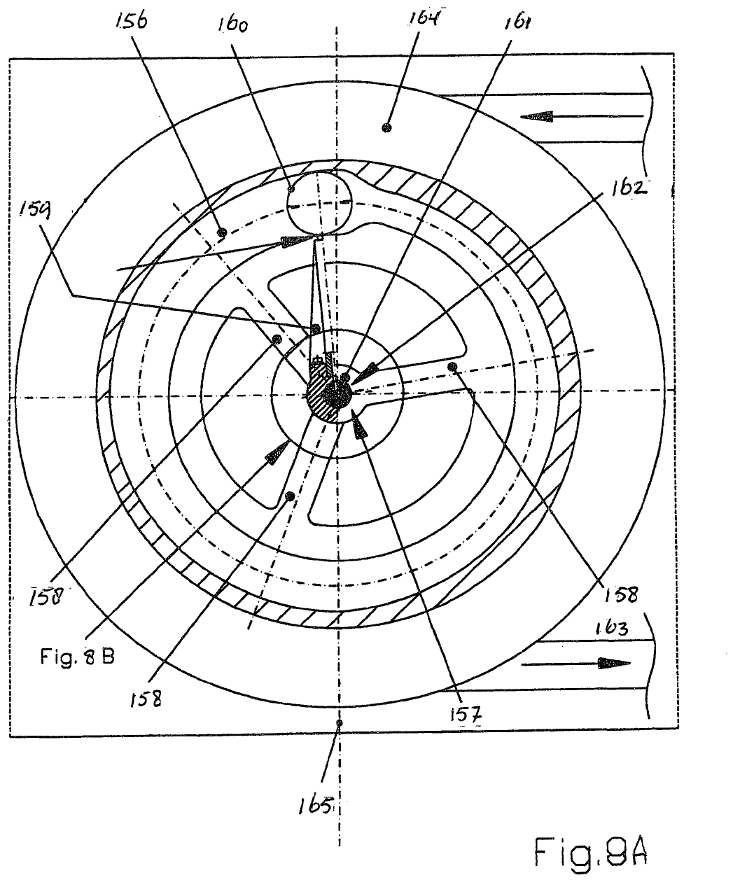

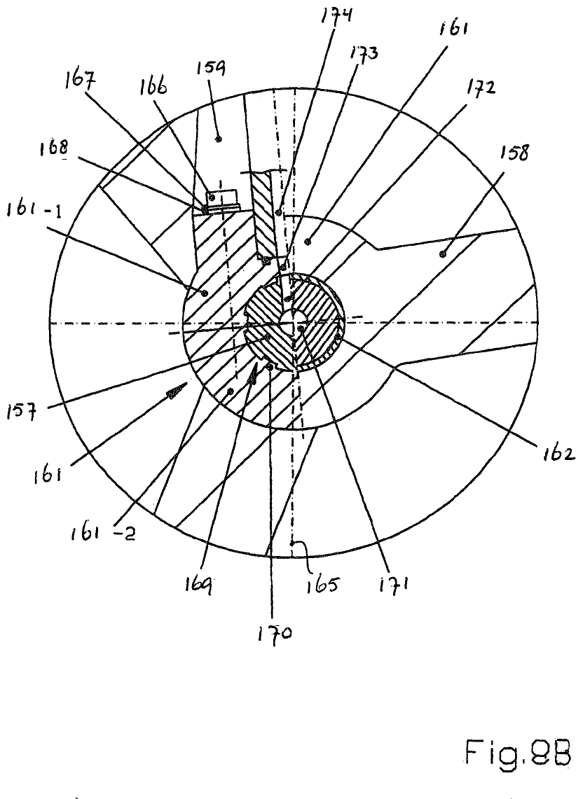

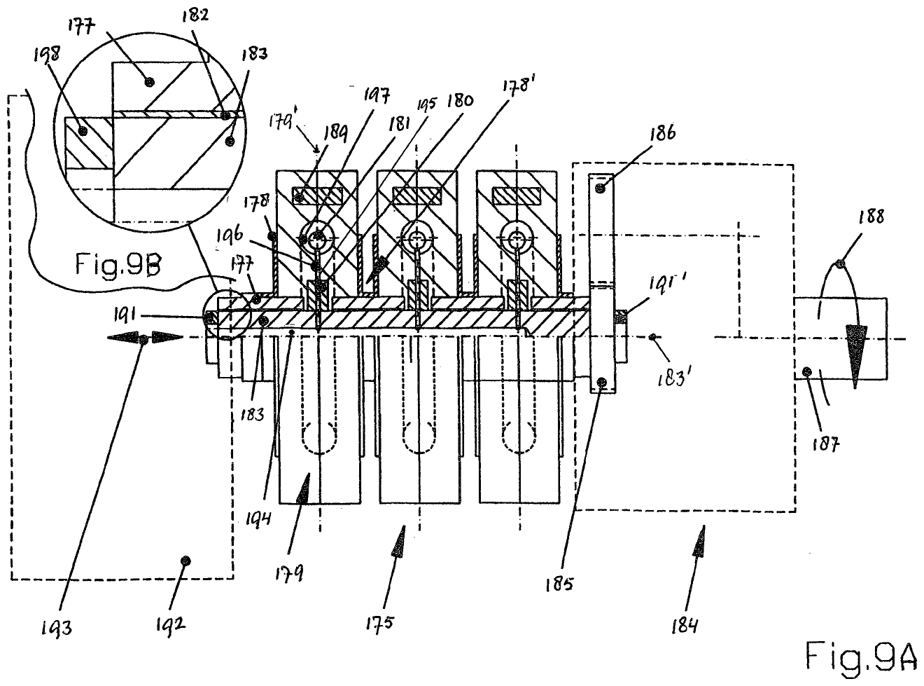

FIG. 9A shows schematically a 3-cylinder motor 175 where the chambers 179 are rotating around a central axle 177. Said chambers 179 are each connected to a central axle 177 by corner brackets 178, 178′ on each side of a chamber 179, so that the torque generated by a chamber 179 is being transferred through said corner brackets to said central axle 177, because said central axle 177 is comprising parts 177′ outside each hub 180 of each piston 181, which are only connected to each other by said brackets 178, 178′, and further comprising a bearing 182, which is comprising parts 182′, corresponding to the parts of said central axle 177. The hubs 180 are mounted on the inner axle 183. Said central axle 177 is communicating with an external gearbox 184, through a gear wheel 185. Said gear wheel is communicating with a gear wheel 186. Said gear wheel 186 is indirectly communicating with the driveshaft axle 187. The rotation direction 188 of drive shaft axle 187. Each chamber 176 is comprising a piston 181, which is fixed, and a ring 189, which functions as a flywheel, and which is positioned farthest from the central axis 177. Said pistons 181 are assembled to the inner axle 183 by a hub 180. Said inner axle 190 is mounted by a fixture 191, 191′ to the foundation and gearbox, respectively. Between the inner axle 183 and the axle 177 is a bearing 182 (please see the enlargement). The pressure management system 192, preferably the ESVT*—system. The communication 193 of the pressure management system 192 with the channel 194 in said inner axle 183. Said channel 194 is communication with the channel 195 in the connecting rod 196 (schematically shown), which is communicating with the space 197 within the piston 181 The centre axis 183′ of the inner axle 183. The centre axis 179′ of the chamber 179.

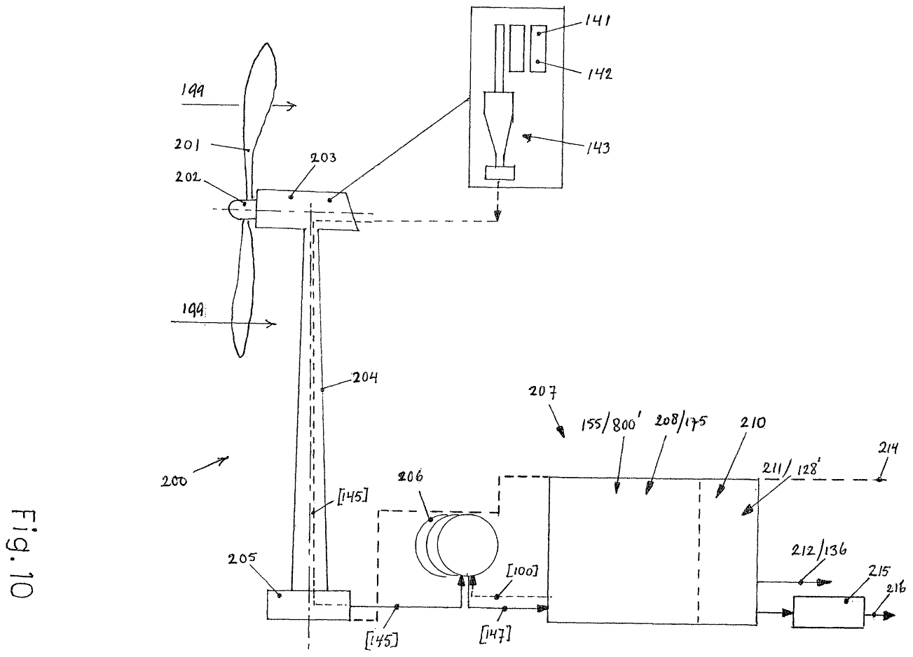

FIG. 9B shows an enlargement (4:1) of the left corner of the central axis 177, and the bearing 183 between the central axle 172 and the inner axle 183. The fixture 198. FIG. 10 shows schematically a wind mill 200 standing on e.g. the country side. The wind direction 199 and the propeller 201. The 1^{st} axle 202 and the top 203 of the windmill 200. The tower 204 stands on its foundation 205. The pressure storage vessel(s) 206 and the building 207 are placed on the ground in which the conversion from pressurized fluid into electricity is taken place.

The reference numbers added with a ′ of devices and assemblies are those of FIGS. 6, 7 and 9A and are being incorporated in the description, in order to improve the teaching of this preferred embodiment.

FIG. 10 shows the schematic configuration of a wind mill standing on the country side, where a Vanderblom Motor is being used. In the top 203 is the wind flow illustrated by arrows 199, turning said propeller 201 and said 1^{st} axle 202, the gearbox/brakes 141′, and the crankshaft 142′ and additionally the main pump 143′. In said tower 204 and between said pressure storage vessel(s) 206/144′ through said foundation 205 and said tower are tubes 208 with channels [145′]—said channels communicate between the main pump 143′ and said pressure storage vessel(s) 206/144′.

Said pressure storage vessel(s) is/are communicating with the Vanderblom Motor 208/175′ assembly's 155′ actuator piston(s) 209/81′, which is/are preferably positioned inside said building 207. The axle 210 is driving an alternator 211/128′. The last mentioned is generating electricity, which is send to the Mains 121/136′. The electricity, generated by said alternator 211/128′ may additionally be provided to a battery 125, which may balance high currents 216 for a very short time, e.g. when a refrigerator motor is starting. The channel [100′] of the regenerative stage is communicating with a pump 213/93′ inside said building 207, while the last mentioned pump 93′ is communicating with said pressure storage vessel(s) 206/144′. Said building 207 and said pressure storage vessel 206 may preferably be positioned under ground level 214, in order to keep clean the surrounding landscape.

For an in-house windmill is the configuration with the Vanderblom Motor similar the one shown in FIG. 10. When a wind mill is mounted in the attic of a house, may the pump there be as well, and a pipe from the attic to the cellar may bring compressed fluid to the pressurized storage vessel when that is positioned there. The Vanderblom Motor may then be mounted on the cellar floor.

Besides the above mentioned embodiment may all other types of said Motor be used, such as the ESVT version, while one or more cylinders may be used. Besides the crankshaft version as shown, may also be the versions based on a circular chamber be used as well.

1. A wind mill for generating wind power, for the conversion of said wind power into electricity and for conserving gained wind power for later use, said wind mill us comprising a rotor or a propeller which is communicating with a 1^{st} axle, for generating a turning moment for said 1^{st} axle, said rotor or propeller is rotating in a flow of wind, further comprising a pump, which is communicating with said 1^{st} axle,
characterized by the fact that
said wind mill is communicating with a Motor, the last mentioned is comprising
said pump which is comprising a piston-chamber combination, said combination is comprising a chamber which is bounded by an inner chamber wall, and comprising a piston in said chamber to be engagingly movable relative to said chamber wall at least between a first position and a second position of said chamber,
said chamber having cross-sections of different cross-sectional area's at the first and second longitudinal positions, and at least substantially continuously differing cross-sectional area's at intermediate longitudinal positions between the first and second longitudinal positions, the cross-sectional area at said second longitudinal position being smaller than the cross-sectional area at said first longitudinal position, for pressurization of a fluid,
and is communicating with said 1^{st} axle,
a pressure storage vessel is communicating with said pump, for storage of compressed fluid, and
said Motor is communicating with a generator, said generator is providing electricity for the use by electric apparatus and/or the Mains.

2. A wind mill according to claim 1, further comprising a selection and controlling device, wherein said device is selecting the amount of electric power to direct use for electric apparatus and or the Mains, and is controlling process parameters of both conversions: those of wind power into pressurized fluid, and/or pressurized fluid into electricity.

3. A wind mill according to claim 1 or 2, said Motor is further comprising an actuator piston according to claim 1 or 2 of WO 2013/026508, wherein said actuator piston is self-propelled in a conically shaped chamber or is fixedly positioned in said chamber, while said chamber is rotating, said actuator piston is communicating with said pressure storage vessel.

4. A wind mill according to claim 1 or 3, said Motor is further comprising a 2^{nd} axle, wherein said 2^{nd} axle is turning on the by said actuator piston's or said chamber's created turning moment, said 2^{nd} axle is communicating with said generator.

5. A wind mill according to claim 2 or 4, further comprising an inlet channel of said pressure storage vessel, wherein said selection- and controlling device is additionally having the possibility to shut down the conversion of pressurized fluid into electricity, by closing the inlet channel of said pressure storage vessel to said actuator piston, thereby adding pressurized fluid to said pressure storage vessel, for later use, and thereby additionally stopping the rotation of said 2^{nd} axle.

6. A wind mill according to claim 3, wherein between said actuator piston and said pressure storage vessel is a regenerating pump stage, said stage is comprising a pump, which is pressuring exited compressed fluid from said actuator piston to said pressure storage vessel.

7. A wind mill according to claim 1 or 2, wherein said wind mill is positioned outside a building, a vehicle or another stationary device.

8. A wind mill according to claim 1 or 2, wherein said wind mill is positioned inside a building or is part of a vehicle or a stationary device.

9. A wind mill according to claim 1, 2 or 8, said wind mill is additionally comprising a flow optimizer, for optimizing the wind flow towards and from said rotor, wherein said wind mill is communicating with said flow optimizer.

10. A wind mill according to claim 9, wherein said wind mill is additionally comprising
said rotor of said wind mill is positioned within the building for which electricity is being generated, turning around said 1^{st} axle,
said rotor is communicating with channels for canalizing said wind flow, to and from said rotor,
said channels are communicating with a turnable channel, turning around a 1^{st} axle, and positioned partly outside the building/vehicle or stationary device,
wherein
said (turnable) channels have walls which can change shape and size, resulting in an approx. laminar flow of the wind through said channels, and
said turnable channel can be turned into a turning position, so that the entry opening is perpendicular the wind flow outside said building,

11. A wind mill according to claim 10, wherein
the sizes and shapes of the walls of said channels and the turning position of the turnable channels are controlled by a computer, which is constantly updating said variables, according to the changing wind parameters such as speed and direction, in order to optimize said wind flow to and from said rotor.

12. A wind mill according to claim 10, wherein
the transition of said turnable channels and said channels is being sealed.

13. A wind mill according to claim 10, wherein
the walls of said channels are optimized for generating a flow through one side of said rotor.

14. A wind mill according to claim 10, wherein
the rotor blades are of a type that irrespective the flow direction through said rotor, said rotor is turning in one direction.

15. A wind mill according to claim 10, wherein
the walls of said channels are optimized for generating a flow through the whole cross-section of the channel in which said rotor mounted.

16. A wind mill according to claim 10, wherein
the incoming wind is at one side of the building, while the outgoing wind is at the opposite side of the building/vehicle or stationary device,

17. A wind mill according to claim 9, wherein the axle of said rotor is communicating with a pump.

18. A wind mill according to claim 1, 7, 8 or 9, wherein said pump is part of the Vanderblom Motor, wherein it is comprising an actuator piston wherein it comprises attached hereto a piston-chamber combination comprising a chamber which is bounded by an inner chamber wall, and comprising an actuator piston inside said chamber to be engagingly movable relative to said chamber wall at least between a first longitudinal position and a second longitudinal position of the chamber,
said chamber having cross-sections of different cross-sectional areas and different circumferential lengths at the first and second longitudinal positions, and at least substantially continuously different cross-sectional areas and circumferential lengths at intermediate longitudinal positions between the first and second longitudinal positions, the cross-sectional area and circumferential length at said second longitudinal position being smaller than the cross-sectional area and circumferential length at said first longitudinal position,
said actuator piston comprising a container which is elastically deformable thereby providing for different cross-sectional areas and circumferential lengths of the piston adapting the same to said different cross-sectional areas and different circumferential lengths of the chamber during the relative movements of the piston between the first and second longitudinal positions through said intermediate longitudinal positions of the chamber,
the actuator piston is produced to have a production-size of the container in the stress-free and undeformed state thereof in which the circumferential length of the piston is approximately equivalent to the circumferential length of said chamber at said second longitudinal position, the container being expandable from its production size in a direction transversally with respect to the longitudinal direction of the chamber thereby providing for an expansion of the piston from the production size thereof during the relative movements of the actuator piston from said second longitudinal position to said first longitudinal position,
the container being elastically deformable to provide for different cross-sectional areas and circumferential lengths of the actuator piston,
wherein
the combination comprises means for introducing fluid from a position outside said container into said container, thereby enabling pressurization of said container, and thereby expanding said container,
a smooth surface of the wall of the actuator piston, at least on and continuously until nearby its contact area with the wall of the chamber,
thereby displacing said container from a second and a first longitudinal position of the chamber, said actuator piston is self-propelled,
the combination comprises means for reducing the volume of said container from a position outside said container by exiting fluid from said container, thereby depressurizing said container when moving from a first to a second longitudinal position,
further comprising a pump comprising a chamber which is bounded by an inner chamber wall, and comprising a piston in said chamber to be engagingly movable relative to said chamber wall at least between a first position and a second position of the chamber, said chamber having cross-sections of different cross-sectional areas at the first and second positions, and at least substantially continuously different cross-sectional areas and circumferential lengths at intermediate positions between the first and second positions, the cross-sectional area at said second position being smaller than the cross-sectional area at said first position, and further comprising a pressure storage vessel, according to WO 2013/026508 A1.

19. A wind mill according to claim 11, wherein said pump is a part of the Vanderblom Motor, wherein it is comprising attached hereto a piston-chamber combination comprising a chamber which is bounded by an inner chamber wall, and comprising an actuator piston inside said chamber to be engagingly movable relative to said chamber wall at least between a first longitudinal position and a second longitudinal position of the chamber,
said chamber having cross-sections of different cross-sectional areas and different circumferential lengths at the first and second longitudinal positions, and at least substantially continuously different cross-sectional areas and circumferential lengths at intermediate longitudinal positions between the first and second longitudinal positions, the cross-sectional area and circumferential length at said second longitudinal position being smaller than the cross-sectional area and circumferential length at said first longitudinal position,
said actuator piston comprising a container which is elastically deformable thereby providing for different cross-sectional areas and circumferential lengths of the piston adapting the same to said different cross-sectional areas and different circumferential lengths of the chamber during the relative movements of the piston between the first and second longitudinal positions through said intermediate longitudinal positions of the chamber,
the actuator piston is produced to have a production-size of the container in the stress-free and undeformed state thereof in which the circumferential length of the piston is approximately equivalent to the circumferential length of said chamber at said second longitudinal position, the container being expandable from its production size in a direction transversally with respect to the longitudinal direction of the chamber thereby providing for an expansion of the piston from the production size thereof during the relative movements of the actuator piston from said second longitudinal position to said first longitudinal position,
the container being elastically deformable to provide for different cross-sectional areas and circumferential lengths of the actuator piston, and communicating with an enclosed space, wherein
the combination comprises means for changing the volume of the enclosed space communicating with said actuator piston of said container from a position outside said container, thereby expanding said container,
a smooth surface of the wall of the actuator piston, at least on and continuously until nearby its contact area with the wall of the chamber,
and thereby displacing said container from a second and a first longitudinal position of the chamber, said actuator piston is self-propelled,
the combination comprises means for changing the volume of the enclosed space communicating with said actuator piston from a position outside said container, thereby reducing the size of said container when moving from a first to a second longitudinal position,
further comprising a pump comprising a chamber which is bounded by an inner chamber wall, and comprising a piston in said chamber to be engagingly movable relative to said chamber wall at least between a first position and a second position of the chamber, said chamber having cross-sections of different cross-sectional areas at the first and second positions, and at least substantially continuously different cross-sectional areas and circumferential lengths at intermediate positions between the first and second positions, the cross-sectional area at said second position being smaller than the cross-sectional area at said first position, and further comprising a pressure storage vessel, according to WO 2013/026508 A1.

20. A wind mill according to claim 1 or 2, where said pump is part of the Vanderblom Motor, wherein it is comprising attached hereto a piston-chamber combination comprising a chamber 156 which is bounded by an inner chamber wall, and comprising an actuator piston inside said chamber to be engagingly movable relative to said chamber wall at least between a first rotational position and a second rotational position of the chamber,
said chamber having cross-sections of different cross-sectional areas and different circumferential lengths at the first and second rotational positions, and at least substantially continuously different cross-sectional areas and circumferential lengths at intermediate rotational positions between the first and second rotational positions, the cross-sectional area and circumferential length at said second rotational position being smaller than the cross-sectional area and circumferential length at said first rotational position,
said actuator piston comprising a container 160 which is elastically deformable thereby providing for different cross-sectional areas and circumferential lengths of the piston adapting the same to said different cross-sectional areas and different circumferential lengths of the chamber during the relative movements of the chamber between the first and second rotational positions through said intermediate rotational positions of the chamber,
the actuator piston is produced to have a production-size of the container in the stress-free and undeformed state thereof in which the circumferential length of the piston is approximately equivalent to the circumferential length of said chamber at said second rotational position, the container being expandable from its production size in a direction transversally with respect to the rotational direction of the chamber thereby providing for an expansion of the piston from the production size thereof during the relative movements of the actuator piston from said second rotational position to said first rotational position,
the container 160 being elastically deformable to provide for different cross-sectional areas and circumferential lengths of the actuator piston,
wherein
the combination comprises means for introducing fluid from a position outside said container into said container, thereby enabling pressurization of said container, and thereby expanding said container,
a smooth surface of the wall of the actuator piston, at least on and continuously until nearby its contact area with the wall of the chamber,
thereby displacing said chamber, such that said contact area is moving from a second and to a first rotational position of the chamber, the chamber is rotating,
the combination comprises means for reducing the volume of said container from a position outside said container by exiting fluid from said container, thereby depressurizing said container when moving from a first to a second rotational position,
further comprising a pump comprising a chamber which is bounded by an inner chamber wall, and comprising a piston in said chamber to be engagingly movable relative to said chamber wall at least between a first position and a second position of the chamber, said chamber having cross-sections of different cross-sectional areas at the first and second positions, and at least substantially continuously different cross-sectional areas and circumferential lengths at intermediate positions between the first and second positions, the cross-sectional area at said second position being smaller than the cross-sectional area at said first position, and further comprising a pressure storage vessel, according to WO 2013/026508 A1.

21. A wind mill according to claim 1 or 2, wherein said pump is a part of the Vanderblom Motor, wherein it is comprising attached hereto a piston-chamber combination comprising a chamber 156 which is bounded by an inner chamber wall, and comprising an actuator piston inside said chamber to be engagingly movable relative to said chamber wall at least between a first rotational position and a second rotational position of the chamber,
said chamber having cross-sections of different cross-sectional areas and different circumferential lengths at the first and second rotational positions, and at least substantially continuously different cross-sectional areas and circumferential lengths at intermediate rotational positions between the first and second rotational positions, the cross-sectional area and circumferential length at said second rotational position being smaller than the cross-sectional area and circumferential length at said first rotational position,
said actuator piston comprising a container 160 which is elastically, deformable thereby providing for different cross-sectional areas and circumferential lengths of the piston adapting the same to said different cross-sectional areas and different circumferential lengths of the chamber during the relative movements of the piston between the first and second rotational positions through said intermediate rotational positions of the chamber,
the actuator piston is produced to have a production-size of the container in the stress-free and undeformed state thereof in which the circumferential length of the piston is approximately equivalent to the circumferential length of said chamber at said second rotational position, the container being expandable from its production size in a direction transversally with respect to the rotational direction of the chamber thereby providing for an expansion of the piston from the production size thereof during the relative movements of the chamber from said second rotational position to said first rotational position,
the container 160 being elastically deformable to provide for different cross-sectional areas and circumferential lengths of the actuator piston, and communicating with an enclosed space,
wherein
the combination comprises means for changing the volume of the enclosed space communicating with said actuator piston of said container from a position outside said container, thereby expanding said container,
a smooth surface of the wall of the actuator piston, at least on and continuously until nearby its contact area with the wall of the chamber,
and thereby displacing said chamber, such that said contact area is moving from a second and a first rotational position of the chamber, the chamber is rotating,
the combination comprises means for changing the volume of the enclosed space communicating with said actuator piston from a position outside said container, thereby reducing the size of said container when moving from a first to a second rotational position,
further comprising a pump comprising a chamber which is bounded by an inner chamber wall, and comprising a piston in said chamber to be engagingly movable relative to said chamber wall at least between a first position and a second position of the chamber, said chamber having cross-sections of different cross-sectional areas at the first and second positions, and at least substantially continuously different cross-sectional areas and circumferential lengths at intermediate positions between the first and second positions, the cross-sectional area at said second position being smaller than the cross-sectional area at said first position, and further comprising a pressure storage vessel, according to WO 2013/026508 A1. ESVT rotational chamber.

22. A building or a vehicle, characterized by the fact that it is comprising a rotor, a Vanderblom Motor (WO 2013/026508), a control- and selection device and a generator according to claims 1 and 2, with or without a flow optimizer according to claim 9.
